(19) United States
(12) Patent Application Publication
(10) Pub. No.: US 2022/0096922 A1
(43) Pub. Date: Mar. 31, 2022

(54) KEYBOARD WITH THUMB-OPERABLE CONTROL BUTTTONS

(71) Applicant: Joseph Walsh, Inverness, IL (US)

(72) Inventor: Joseph Walsh, Inverness, IL (US)

(21) Appl. No.: 17/448,951

(22) Filed: Sep. 27, 2021

Related U.S. Application Data
(60) Provisional application No. 63/083,323, filed on Sep. 25, 2020.

(51) Int. Cl. A63F 13/24; G06F 3/02; A63F 13/22

(52) U.S. Cl. CPC A63F 13/24; G06F 3/0219; A63F 2300/1043; A63F 2300/1018; A63F 13/22

(57) ABSTRACT

A keyboard with a thumb-operable control button on the front surface is disclosed. In one embodiment, the keyboard comprises an upper surface, a lower surface, a front surface, a back surface, a left surface, and a right surface. A plurality of keys disposed on the upper surface of the housing includes alphanumeric and non-alphanumeric keys arranged into rows and a thumb-operable spacebar arranged below the alphanumeric keys and non-alphanumeric keys. A thumb-operable control button is disposed on the front surface of the housing, the thumb-operable control button configured to be depressed at an angle of depression perpendicular to the front surface, and wherein the thumb-operable control button is independently and selectively configured to perform a function identical to a function of one of the alphanumeric keys or the non-alphanumeric keys when depressed. This arrangement can greatly improve both functionality and accessibility to certain keys on the upper surface of housing.

### CROSS-REFERENCE TO RELATED APPLICATIONS

This patent application claims the benefit of U.S. Provisional Patent Application 63/038,323 filed on Sep. 25, 2020 entitled “Keyboard with Thumb-Operable Control Buttons”, the entire contents of which are incorporated herein by reference.

### FIELD OF THE INVENTION

The present invention relates to computer keyboards and, more particularly, to such computer keyboards typically used for playing computer games.

### BACKGROUND OF THE INVENTION

The use of a keyboard to control a computer, laptop, or other similar electronic devices as an input device is well-known in the art. A typical computer system uses a keyboard for text input using alphanumeric keys and additional input using non-alphanumeric keys including direction arrows, control, and a thumb-operable spacebar. When the computer system is being used for the purpose of playing video games, the keyboard can be used to trigger actions in the game.

Referring to FIG. 1, a conventional keyboard 10 arranged in the standard “QWERTY” arrangement is shown. The keyboard 10 includes alphanumeric keys 12 and nonalphanumeric keys 14. The top row of alphanumeric keys 12 begins with the letters “Q”, “W”, “E”, “R”, “T”, and “Y”, and a thumb-operable spacebar 16 is between a user and the alphanumeric keys 12. A home row 20 is the center row of keys 12, 14 on the keyboard 10. “A”, “S”, “D,” “F” and “J”, “K”, “L” are the home keys on the home row 20. When using the keyboard 10, typists traditionally arrange their hands wherein the left and right index fingers rest on the “F” and “J” keys and the remaining fingers outside of the thumb naturally fall onto the adjacent keys in the home row 20. Both of the user's thumbs would rest on the thumb-operable spacebar 16. Accordingly, a user has two thumbs allocated to a single button.

When a user plays video games on a computer system, one of the user's hands may be placed on a mouse, leaving the other hand on the keyboard 10 with one thumb responsible for depressing the thumb-operable spacebar 16. In this configuration, it is difficult for a user to utilize their thumb to press any buttons other than the thumb-operable spacebar 16. Further, when a user is utilizing keyboard 10 to design, write, and test code for computer software, the thumb-operable spacebar 16 is rarely used, resulting in the user's thumbs being seldomly used.

Therefore, it would be desirable to provide a keyboard wherein the front surface of the keyboard has control buttons that can be mapped to perform the functions of the other keys on the upper surface of the keyboard that are not reachable by a user's thumb when their fingers are on the home row of the keyboard.

### SUMMARY OF THE INVENTION

A new keyboard has been invented which includes one or more thumb-operable control buttons that may be programmed. The thumb-operable control buttons are located on a front surface of the keyboard, between the user and the space bar, so that they are easily accessible.

Accordingly, in an aspect of the present invention, the present invention may be generally characterized as providing a keyboard having a housing with an upper surface, a lower surface, a front surface, a back surface, a left surface, and a right surface. The front surface, the back surface, the left surface, and the right surface extend between the upper surface and the lower surface. A plurality of keys is disposed on the upper surface of the housing, and each key is configured to be depressed at an angle of depression perpendicular to the upper surface. The plurality of keys includes alphanumeric keys and non-alphanumeric keys arranged into rows and a thumb-operable spacebar arranged below the alphanumeric keys and non-alphanumeric keys. A thumb-operable control button is disposed on the front surface of the housing and is configured to be depressed at an angle of depression perpendicular to the front surface. The thumb-operable control button is independently and selectively configured to perform a function identical to a function of one of the alphanumeric keys or the non-alphanumeric keys when depressed.

In another aspect, the present invention may be characterized, generally, as providing a method for playing a video game by: connecting a keyboard according to the present invention to a computer system, running a game on the computer system, and using the keyboard to play the game.

In a further another aspect, the present invention may be generally characterized as providing a keyboard having a housing with an upper surface, a lower surface, a front surface, a back surface, a left surface, and a right surface. The front surface, the back surface, the left surface, and the right surface extend between the upper surface and the lower surface. A plurality of keys disposed on the upper surface of the housing are provided, including keys that are configured to be depressed at an angle of depression perpendicular to the upper surface. The plurality of keys includes alphanumeric keys and non-alphanumeric keys arranged into rows and a thumb-operable spacebar is arranged below the alphanumeric keys and non-alphanumeric keys. A plurality of thumb-operable control buttons are disposed on the front surface of the housing and are configured to be depressed at an angle of depression perpendicular to the front surface and are independently and selectively configured to perform a function identical to a function of one of the alphanumeric keys or the non-alphanumeric keys when depressed.

These and other aspects and embodiments of the present invention will be appreciated by those of ordinary skill in the art based upon the following description of the drawings and detailed description of the preferred embodiments.

### BRIEF DESCRIPTION OF THE DRAWINGS

The attached drawings will make it possible to understand how the invention can be produced and practiced, in which:

FIG. 1 is a top view of a prior art keyboard showing typical locations for alphanumeric and non-alphanumeric keys;

FIG. 2 is a side and top perspective view of a keyboard having a thumb-operable control button according to one or more embodiments of the present invention;

FIG. 3 is side and top perspective view of another keyboard having a thumb-operable control button according to one or more embodiments of the present invention;

FIG. 4 is a side and top perspective view of another keyboard having a thumb-operable control button according to one or more embodiments of the present invention;

FIG. 5 is a side and top perspective view of yet another keyboard according to one or more embodiments of the present invention; and,

FIG. 6 is a schematic view showing a keyboard according to one or more embodiments of the present invention being used as an input to a computer system.

### DETAILED DESCRIPTION OF THE PREFERRED EMBODIMENTS

As mentioned above, a new keyboard has been invented which includes one or more thumb-operable control buttons that may be programmed. The thumb-operable control buttons are located on a front surface of the keyboard, between the user and the space bar, so that they are easily accessible.

Accordingly, with reference the attached drawings, one or more embodiments of the present invention will now be described with the understanding that the described embodiments are merely preferred and are not intended to be limiting.

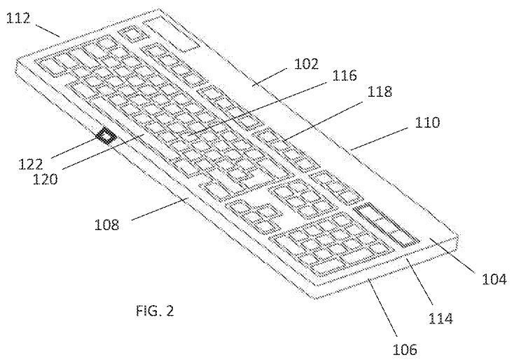

With reference to FIG. 2, the present keyboard 100 includes a housing 102. The housing 102 has an upper surface 104, a lower surface 106, a front surface 108, a back surface 110, a left surface 112, and a right surface 114. The front surface 108, the back surface 110, the left surface 112, and the right surface 114 extend vertically between the upper surface 104 and lower surface 106. The six surfaces 104, 106, 108, 110, 112 and 114 can be configured to have any width and height to enable different housing configurations. For example, the surfaces 104, 106, 108, 110, 112 and 114 may be configured such that the height of the back surface 110 is greater than the height of the front surface 108, resulting in keyboard 100 being tilted ergonomically. The housing 102 can be made from a variety of materials, including brass, steel, aluminum, plastics, and carbon fiber.

As shown in FIG. 2, the upper surface 108 of the keyboard 100 has a plurality of alphanumeric keys 116 and a plurality of non-alphanumeric keys 118 disposed on the upper surface 104. Each key 116, 118 is configured to be depressed at an angle of depression generally perpendicular to the upper surface 104. For example, the keys 116, 118 may be configured to be depressed at an angle of depression within twenty degrees of a ninety-degree angle between a vertical axis running in and out of the paper of FIG. 2 and the upper surface 104. The keys 116, 118 can be made from a variety of materials, including steel, aluminum, plastics, and carbon fiber.

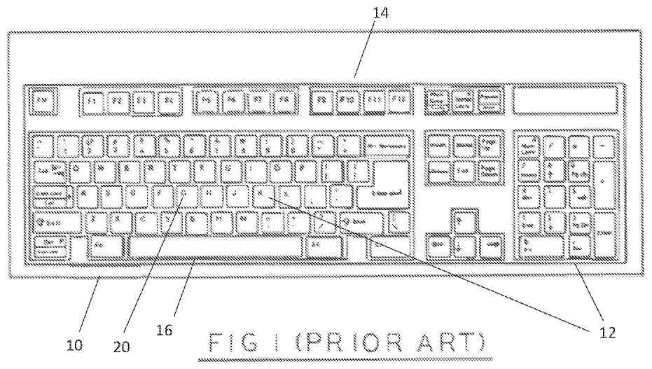

The alphanumeric keys 116 include all letters and numbers, including all letters starting from “A” to “Z” and numbers starting from “0” to “9”. In at least one embodiment, the alphanumeric keys 116 are arranged in the standard “QWERTY” layout wherein the first six keys on the top left row of the keyboard contains the keys “Q”, “W”, “E”, “R”, “T”, and “Y”. Those having skill in the art will understand that the arrangement of alphanumeric keys 116 can be different and not necessarily arranged in the “QWERTY” layout. See, FIG. 1.

The non-alphanumeric keys 118 include the remaining keys including punctuation characters and symbol characters. The non-alphanumeric keys 118 may include “!”, “@”, “&”, “(“,”)”, “-”, “[“,”]”, “{“,”}”, “:”, “;”, “””, “,”, “?”, “/”, “*”, “#”, “$”, “%” and “\hat{ }”. The non-alphanumeric keys 118 also include the thumb-operable spacebar 120, a control key, a shift key, an enter key, an ALT key, a delete key, and directional keys. The non-alphanumeric keys 118 can also include one or more function keys configured to perform a function identical to one of the alphanumeric keys 116 or non-alphanumeric keys 118. FIG. 1 displays how the non-alphanumeric keys 14 would typically be arranged in a “QWERTY” layout. The depicted arrangement of non-alphanumeric keys 14 is an example and other arrangements may be utilized. Those having ordinary skill in the art would understand that the non-alphanumeric keys 118 can be arranged in any manner alongside the “QWERTY” layout. Similarly, the non-alphanumeric keys 118 can be arranged in any manner when the alphanumeric keys 116 are arranged in a manner other than the “QWERTY” layout.

Further, while the depicted embodiments show mechanical or physical keys, it is contemplated that the keys 116, 118 are located on a touch screen (or a portion of a touch screen) disposed on the upper surface 104. As is known, in such an arrangement, the displayed keys are activated by a user depressing the touch screen at the location of each key in a direction towards the display screen.

As shown in FIG. 2, the keyboard 100 includes at least one thumb-operable control button 122 disposed on the front surface 108. The thumb-operable control button 122 is configured to be depressed at an angle of depression generally perpendicular to the front surface 108. For example, the thumb-operable control button 122 may be configured to be depressed at an angle of depression within twenty degrees of a ninety-degree angle between a horizontal axis running in and out of the paper of FIG. 2 and the front surface 108.

Additionally, the thumb-operable control button 122 is configured to perform a function identical to a function of one of the alphanumeric keys 116 or non-alphanumeric keys 118 when depressed. While the thumb-operable control button 122 can have an initial default function, such as performing the function of the thumb-operable spacebar 120 when depressed, the function of the thumb-operable control button 122 may be changed to perform the function of any of the plurality of keys 116, 118 on the upper surface 104.

As shown in FIG. 2, the thumb-operable control button 122 is laterally aligned to a longitudinal center of the thumb-operable spacebar 120. Specifically, a center of the thumb-operable control button 122 is aligned with the center of the spacebar 120 on its longitudinal axis. However, the thumb-operable control button 122 can also be aligned to the left or right of the longitudinal center of the thumb-operable spacebar 120.

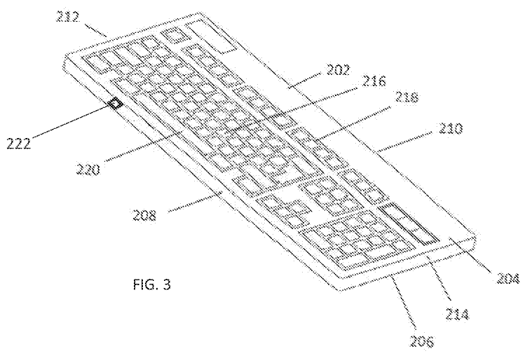

For example, as shown in FIG. 3, the center of the thumb-operable control button 222 is aligned with the left lateral edge of the spacebar 220. The remaining portions of FIG. 3 are the same as discussed herein relative to FIG. 2 with the reference numerals being increased by “100.” Thus, those related portions of the discussion of FIG. 2 are incorporated herein mutatis mutandis.

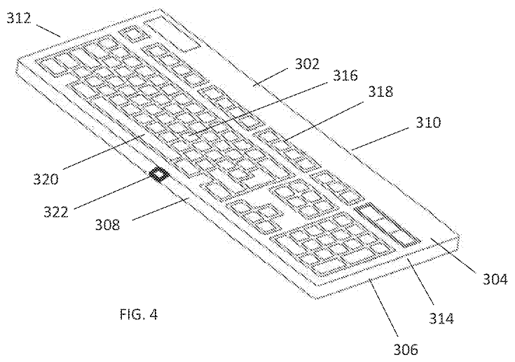

Further, as shown in FIG. 4, the center of the thumb-operable control button 322 is aligned with the right lateral edge of the spacebar 320. The remaining portions of FIG. 4 are the same as discussed herein relative to FIG. 2 with the reference numerals being increased by “200.” Thus, those related portions of the discussion of FIG. 2 are incorporated herein mutatis mutandis.

For example, a user might prefer the keyboards 200, 300 to have the thumb-operable control buttons 222, 322 laterally aligned to the left or right of the center of the thumb-operable spacebars 220, 320 in order to avoid interference between the hands in a normal configuration. Also, a user of the keyboards 200, 300 might configure the thumb-operable control button 222, 322 to perform the function of a key normally activated by the left or right hand in order to optimize functionality, thus allowing both hands to activate a key normally activated by one hand

Returning to FIG. 2, the thumb-operable control button 122 may be configured to perform the functions of at least a control key, a shift key, an enter key, an ALT key, a delete key, a tab key, and directional keys. The thumb-operable control button 122 may also be configured to perform the function of the spacebar 120. Further, the thumb-operable control button 122 may be configured to perform a customized function not performed by any of the alphanumeric keys 116 or non-alphanumeric keys 118. The customized function is programmatically set by the user of the keyboard through use of a computer system. For example, some video games utilize multiple keys simultaneously, such as the spacebar 120 and a directional key.

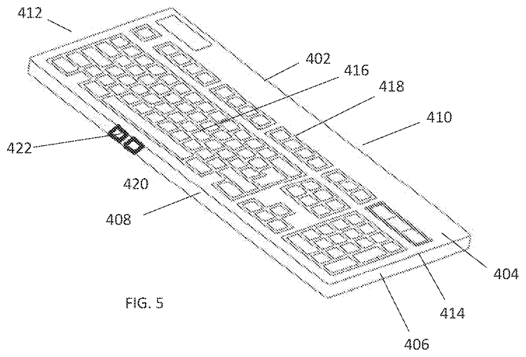

Those familiar with the art will appreciate that multiple thumb-operable control buttons 422 may be disposed on the front surface 408, as shown in FIG. 5. The thumb-operable control buttons 422 have all the functionalities of the thumb-operable control button 122 shown in FIG. 2. Having multiple thumb-operable control buttons 422 allows a user to depress more than one thumb-operable control buttons 422 at the same time to simultaneously perform two functions at once. Further, a center of the thumb-operable control buttons 422 can be aligned with the center of the spacebar 420 on its longitudinal axis or aligned with the right or left lateral edge of the spacebar 420. In another further embodiment, the thumb-operable control buttons 422 can be separated such that one or more thumb-operable control buttons 422 are laterally aligned to the left of the longitudinal center of the thumb-operable spacebar 420 and one or more thumb-operable control buttons 422 are laterally aligned to the right of the longitudinal center of the thumb-operable spacebar 420. While FIG. 5 displays two thumb-operable control buttons 422, those skilled in the art would understand that more thumb-operable buttons can be disposed on the front surface 408.

The remaining portions of FIG. 5 are the same as discussed herein relative to FIG. 2 with the reference numerals being increased by “300.” Thus, those related portions of the discussion of FIG. 2 are incorporated herein mutatis mutandis.

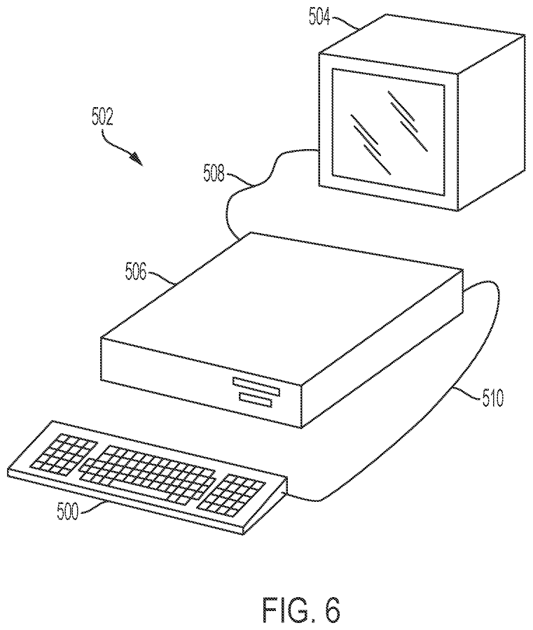

A method of playing a video game with a keyboard 500 according to the present invention on a computer system 502 is shown in and described with respect to FIG. 6. The computer system 502, as is known, includes a monitor 504, or other display device, that communicates with a computer 506 through connection 508. The computer 506 includes one or more processors that perform functions that are typically stored in memory. The keyboard 500 is connected to the computer 506 through connection 510. In one aspect of the present disclosure, a user can connect the present keyboard to the computer system 502 to play video games.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A keyboard comprising:
a housing comprising an upper surface, a lower surface, a front surface, a back surface, a left surface, and a right surface, front surface, the back surface, the left surface, and the right surface each extending between the upper surface and the lower surface;
a plurality of keys disposed on the upper surface of the housing, each key configured to be depressed at an angle of depression perpendicular to the upper surface, the plurality of keys comprising:
alphanumeric keys,
non-alphanumeric keys, wherein the alphanumeric keys and the non-alphanumeric keys arranged into rows, and
a thumb-operable spacebar arranged below the alphanumeric keys and non-alphanumeric keys; and,
a thumb-operable control button disposed on the front surface of the housing,
wherein the thumb-operable control button is configured to be depressed at an angle of depression perpendicular to the front surface, and
wherein the thumb-operable control button is independently and selectively configured to perform a function identical to a function of one of the alphanumeric keys or the non-alphanumeric keys when depressed.

2. The keyboard of claim 1, wherein the alphanumeric keys are arranged into rows in a standard “QWERTY” arrangement.

3. The keyboard of claim 1 further comprising:
a plurality of thumb-operable control buttons disposed on the front surface of the housing,
wherein each of the thumb-operable control buttons is configured to be depressed at an angle of depression perpendicular to the front surface, and
wherein the thumb-operable control buttons are each independently and selectively configured to perform a function identical to a function of one of the alphanumeric keys or the non-alphanumeric keys when depressed.

4. The keyboard of claim 1, wherein the thumb-operable spacebar is arranged between the alphanumeric keys and a user of the keyboard.

5. The keyboard of claim 1, wherein the thumb-operable control button is laterally aligned with a longitudinal center of the thumb-operable spacebar.

6. The keyboard of claim 1, wherein the thumb-operable control button is laterally aligned to a right of a longitudinal center of the thumb-operable spacebar.

7. The keyboard of claim 1, wherein the thumb-operable control button is laterally aligned to a left of a longitudinal center of the thumb-operable spacebar.

8. The keyboard of claim 1, further comprising a second thumb-operable control button disposed on the front surface of the housing
wherein the second thumb-operable control button is configured to perform the function of the thumb-operable spacebar when depressed.

9. The keyboard of claim 1, wherein the plurality of keys disposed on the upper surface further comprises:
a function key configured to perform a function identical to one of the alphanumeric keys or non-alphanumeric keys.

10. The keyboard of claim 9, wherein the thumb-operable control button is configured to perform the function of the function key.

11. The keyboard of claim 1, wherein the non-alphanumeric keys comprise:
a control key;
a shift key;
an enter key;
an alt key;
a delete key
a tab key; and
four directional keys.

12. A method comprising:
connecting a keyboard according to claim 1 to a computer system;
running a game on the computer system; and
using the keyboard to play the game.

13. A keyboard, comprising:
a housing comprising an upper surface, a lower surface, a front surface, a back surface, a left surface, and a right surface, each of the front surface, the back surface, the left surface, and the right surface extending between the upper surface and the lower surface;
a plurality of keys disposed on the upper surface of the housing, each key configured to be depressed at an angle of depression perpendicular to the upper surface, the plurality of keys comprising:
alphanumeric keys,
non-alphanumeric keys, the alphanumeric keys and the non-alphanumeric keys arranged into rows, and
a thumb-operable spacebar arranged below the alphanumeric keys;
a plurality of thumb-operable control buttons disposed on the front surface,
wherein the thumb-operable control buttons are each configured to be depressed at an angle of depression perpendicular to the front surface of the housing, and
wherein the thumb-operable control buttons are each independently and selectively configured to perform a function identical to a function of one of the plurality of keys when depressed.
